(19) United States
(12) Patent Application Publication
(10) Pub. No.: US 2025/0325997 A1
(43) Pub. Date: Oct. 23, 2025

(54) METHOD AND SYSTEM FOR REFILLING A BOTTLE WITH LIQUID

(71) Applicant: TECHNIPLAST, LOUVIERS (FR)

(72) Inventor: Jean-Philippe LAMBOUX, LOUVIERS (FR)

(21) Appl. No.: 18/711,159

(22) PCT Filed: Nov. 16, 2022
(86) PCT No.: PCT/FR2022/052111

§ 371 Date: Oct. 18, 2024

(30) Foreign Application Priority Data
Nov. 19, 2021 (FR) 21 12251

(51) Int. Cl. B05B 11/00; B65B 3/10

(52) U.S. Cl. CPC B05B 11/0097; B65B 3/10

(57) ABSTRACT

The invention relates to a method for refilling a bottle with liquid, in a system (10) comprising, vertically:
a liquid refill (12) and a bottle (14) to be refilled, which is or are produced in the form of a manually deformable container,
a device (16) for transferring liquid, arranged between the refill (12) and the bottle (14) and comprising two parts (18, 20), a first part (18) being attached to the refill (12),
   the method comprising:
rotating one part relative to the other part in order to bring them into a first rotational position in which they jointly define a passage for the liquid from the refill to the bottle,
applying external pressure to a manually deformable container with a view to transferring liquid from the refill (12) to the bottle (14) through the liquid passage,
rotating one part relative to the other into a second rotational position in which the passage of liquid is obstructed.

### TECHNICAL FIELD

The present invention relates to the field of refilling with liquid a bottle to be refilled from a source bottle called a refill. The present invention relates more particularly to a method for refilling with liquid at least one bottle to be refilled from a refill by means of a liquid transfer device, and also a system comprising a liquid transfer device of this type to allow filling of said at least one bottle to be refilled by the refill. Prior art

Known from patent EP 2 500 277 is a device for transferring liquid from a first container called the source or refill to a second container called the bottle to be refilled and placed below the refill. The device is attached at each of its two opposite ends to one of the two containers. The device includes two parts mounted rotating relative to one another and each comprising two ducts, namely a liquid duct and an air duct. By a rotation movement of one part relative to the other, the respective liquid and air ducts of the two parts can be aligned with one another and thus allow the passage of liquid from the refill to the bottle to be refilled through the respective liquid ducts of the two parts aligned with one another, while the air passes from the bottle to be refilled to the refill through the respective air ducts of the two parts aligned with one another. A reverse rotation movement of one of the parts relative to the other has the effect of misaligning the respective ducts with one another, liquid on the one hand and, on the other hand, air, thus preventing any transfer of liquid.

Although a device of this type is particularly satisfactory, it nevertheless proves difficult to use when the liquid to be transferred is of the dishwashing liquid, shower gel or oil type. In fact, the ducts are of a relatively small diameter because they must be able to be introduced into the neck of the bottle to be refilled and the viscosity of the liquid makes liquid flow through the ducts difficult, perhaps impossible. In addition, when the bottle to be refilled is nearly full, liquid is likely to go back up the air ducts and obstruct them, perturbing, perhaps blocking the resumption of flow during the following use.

There exists therefore a need to simply and effectively refill a bottle to be refilled with a liquid, for example of the shower gel, dishwashing liquid or oil type, from a liquid refill by means of a suitable liquid transfer device.

### DISCLOSURE OF THE INVENTION

The invention thus has as its object a method for refilling at least one bottle with liquid in a system comprising, with the system arranged vertically along an axis Z:
a refill containing liquid,
at least one bottle to be refilled arranged below the refill, said at least one bottle to be refilled and/or the refill being produced in the form of a manually deformable container,
a liquid transfer device arranged between the refill and said at least one bottle to be refilled, the liquid transfer device comprising at least two parts which are, on the one hand, mounted in rotation relative to one another around the axis Z and, on the other hand, bonded in axial translation along the axis Z, a first of the two parts being attached to the refill, the method comprising the following steps:
rotating one of the two parts relative to the other part in order to bring the two parts into a first relative rotation position wherein the two parts jointly define at least one passage for the liquid from the refill to said at least one bottle to be refilled, namely a single liquid passage per bottle to be refilled,
exerting external pressure on the manually deformable container or on one of the two manually deformable containers for the purpose, on the one hand, of causing a transfer of liquid from the refill to said at least one bottle to be refilled through said at least one liquid passage of the transfer device and, on the other hand, causing the air contained in said at least one bottle to be refilled to rise into the refill through said at least one liquid passage.

The aforementioned method allows simple and effective transferring of the liquid of the shower gel, dishwashing liquid or oil type, i.e. liquid generally more viscous than perfume, from a liquid refill to one or more bottles to be refilled arranged below by facilitating the transfer of a liquid of this type and by avoiding obstructing the passage for the transfer of the liquid. The transfer of the liquid that is more viscous than perfume is carried out based on a simple pressure exerted from outside onto one of the two containers (the one which is manually deformable or one of the two when they are both manually deformable). The external pressure exerted on the container (compression of the container) has the effect of increasing the pressure inside the container. When the container on which the pressure is exerted is the refill, the increase in internal pressure has the consequence of directly causing the transfer of liquid, through the passage, into the bottle(s) to be refilled by simple internal hydrostatic pressure in the refill. When the container on which the pressure is exerted is the bottle to be refilled, the latter has shape memory and the action of exerting external pressure on this bottle (this action has the direct consequence of making the air present in the bottle rise into the refill) is followed by release of the pressure exerted in order to aspire (by reduced pressure) liquid which is present in the refill to transfer it into the bottle. The combination of the two consecutive actions (pressure and release) accomplishes a pumping action as it were and thus allows, on the one hand, the liquid present in the refill to flow into the bottle to be refilled under the influence of the variation of internal pressure, through the passage and, on the other hand, air present in the bottle to be refilled to rise into the refill through the same passage. Generally, a quantity of liquid is thus transferred from the refill to the bottle to be refilled by this pumping action. To be able to exert this dual action, the container must have an outer envelope which can be manually deformed in an elastic manner under the influence of external pressure (by a user for example), tending to compress the container and therefore reduce the internal volume of its outer envelope (increase of the internal pressure of the container). When the pressure ceases to be exerted on the outer envelope, its elastic properties (shape memory) allow it to resume its initial, non-deformed shape (the internal volume of the envelope resumes its initial value), this in a manner that is repeated over time. The gestures to be carried out by the user (pressure and release) are particularly simple and intuitive when it is a matter of distributing a liquid product from a first container above a second lower container without or with little recovery of outside air. Unlike the prior art described above, in both configurations shown above, the transfer or the flow of liquid is not caused by the action of gravity but by that of external action on one of the containers.

It will be noted that the liquid transfer device defines only a single passage for the liquid when there is only a single bottle to be refilled. Moreover, as already mentioned above, to balance the pressures between the refill and the bottle to be refilled in order that the liquid can be transferred from the refill to the bottle, the air also uses the passage defined for the transfer of the liquid, but flowing counter-current to the latter.

When the user desires to stop the distribution he closes/obstructs said at least one passage by rotating one of the two parts relative to the other (in the reverse direction of the first relative rotation movement between the two parts for opening the passage) in order to bring the two parts into a second relative rotation position in which said at least one liquid passage is obstructed. The liquid distribution is thus interrupted in a “clean” manner without continuing to transfer liquid into the bottle to be refilled.

According to other possible features:
after having exerted external pressure on the manually deformable container or on one of the two manually deformable containers, the method comprises the following step of releasing the exerted external pressure;
the method comprises the following step of repeating the actions of exerting external pressure on the manually deformable container with shape memory or on one of the two manually deformable containers with shape memory and releasing the external pressure to refill said at least one bottle to be refilled;
the refill being produced in the form of a manually deformable container with shape memory, the method comprises the steps of:
   exerting external pressure on the manually deformable container of the refill in order to transfer liquid from the refill (located above) to said at least one bottle to be refilled (located below), and releasing the external pressure on the manually deformable container in order to cause the air from said at least one bottle to be refilled to rise into the refill;
said at least one bottle to be refilled being produced in the form of a manually deformable container with shape memory, the method comprises the steps of:
   exerting external pressure on the manually deformable container of said at least one bottle to be refilled (located below) in order to cause the air from said at least one bottle to be refilled to rise into the refill (located above), and releasing the external pressure on the manually deformable container of said at least one bottle to be refilled in order to cause the transfer of liquid from the refill to said at least one bottle to be refilled by aspiration of the liquid contained in the refill;
the method comprises a step during which the liquid transfer device is rotated relative to said at least one bottle to be refilled, first, to screw the liquid transfer device to said at least one bottle to be refilled and then to rotate one of the two parts relative to the other part in order to bring the two parts into the first relative rotation position in which the two parts jointly define said at least one passage for the liquid from the refill to said at least one bottle to be refilled.

The invention also has as its object a system for refilling at least one bottle with liquid comprising, with the system arranged vertically along an axis Z:
a refill containing liquid,
at least one bottle to be refilled arranged below the refill,
a liquid transfer device arranged between the refill and said at least one bottle to be refilled, the liquid transfer device comprising at least two parts which are, on the one hand, mounted in rotation relative to one another around the axis Z between a first relative rotation position and a second relative rotation position and, on the other hand, bonded in axial translation along the axis Z, a first of the two parts being attached to the refill, the two parts being jointly configured so as to define at least one passage for the transfer of the liquid from the refill to said at least one bottle to be refilled and the transfer, to the refill, of the air contained in said at least one bottle to be refilled, in the first relative rotation position, and to obstruct said at least one liquid passage, in the second relative rotation position, said at least one bottle to be refilled and/or the refill being produced in the form of a manually deformable container and able to be manually deformed under the influence of external pressure to cause a variation of internal pressure in the container thus deformed.

The system includes the same advantages as those mentioned above in relation with the method and will therefore not be repeated.

According to other possible features:
the liquid transfer device lacks an air passage distinct from the liquid passage, particularly for the passage of air from the bottle to be refilled to the refill;
said at least one passage for the liquid defined in the transfer device when the latter is in the first relative rotation position has a passage cross section comprised between 5 mm² and 100 mm², preferably between 50 and 100 mm²;
the liquid transfer device comprises, in each of the two parts, at least one passage portion configured so that, when the two parts are in the first relative rotation position, the passage portions of the two parts are in fluid communication with one another in order to define said at least one passage for the liquid and, when the two parts are in the second relative rotation position, the passage portions of the two parts are not in fluid communication with one another;
the second part is attached to said at least one bottle to be refilled;
the second part is attached to said at least one bottle to be refilled by screwing, particularly onto the threaded neck of the bottle to be refilled;
the refill is selected among a manually deformable container with shape memory or a manually deformable container without shape memory;
the system includes a liquid-tight zone between the liquid transfer device and said at least one bottle to be refilled.

### BRIEF DESCRIPTION OF THE DRAWINGS

Other features and advantages will appear during the description that follows, given solely by way of a non-limiting example and provided with reference to the appended drawing, in which:

FIG. 1 is a longitudinal section view of a liquid transfer system during use (pressurization step) according to one embodiment of the invention;

FIG. 2 is a partial enlarged view of the system of FIG. 1 showing in a more detailed manner the liquid transfer device in the open position;

FIG. 3A is an enlarged perspective view from below of the first part constituting the liquid transfer device of FIG. 2;

FIG. 3B is a view in transverse section showing the first and second parts constituting the liquid transfer device in another relative rotation position corresponding to a closed position of the liquid transfer device;

FIG. 3C is a transverse section view showing the first and second parts constituting the liquid transfer device in a relative rotation position corresponding to another open position of the liquid transfer device

FIG. 4 is an enlarged perspective top view of the second part constituting the liquid transfer device of FIG. 2;

FIG. 5 is a view of the liquid transfer device of FIG. 2 in a closed position;

FIG. 6 is a view of the system of FIG. 1 during use (releasing step);

FIG. 7 is a longitudinal section view of a liquid transfer system during use (pressurization step) according to another embodiment of the invention;

FIG. 8 is a view of the system of FIG. 7 during use (releasing step);

FIG. 9 is a longitudinal section view of a liquid transfer system during use (pressurization step) according to another embodiment of the invention;

FIG. 10 is a view of the system of FIG. 9 during use (releasing step).

### DESCRIPTION OF THE EMBODIMENTS

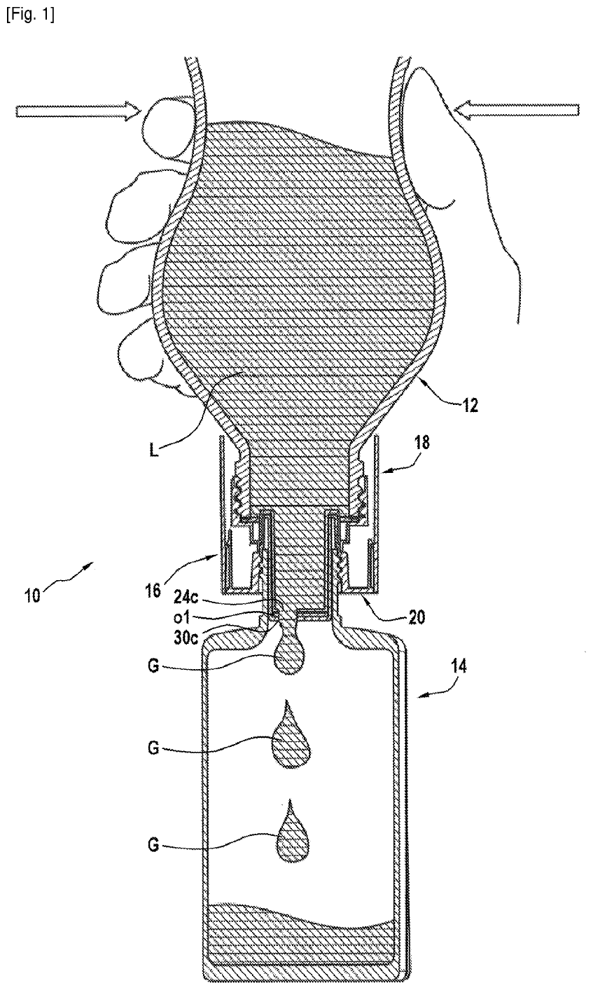

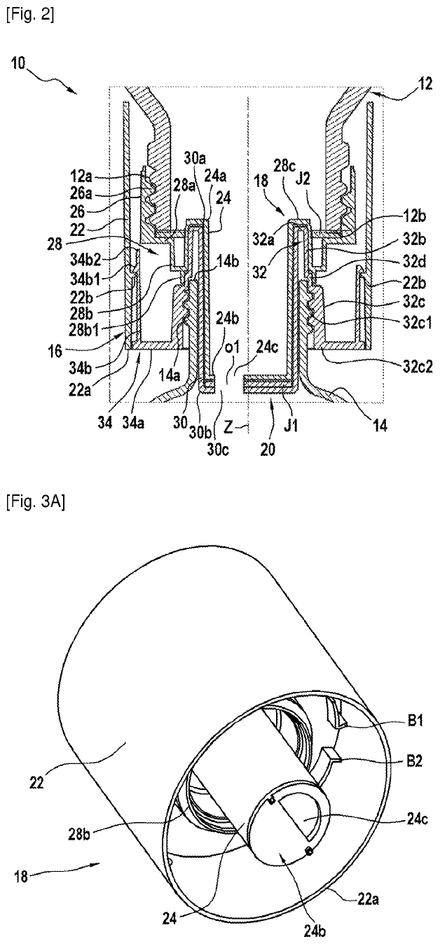

A system for refilling with liquid 10 according to one embodiment is shown in FIG. 1. This system 10 comprises a liquid refill forming a first container or source bottle 12 and at least one second container or bottle to be refilled with liquid 14 from the refill 12. Here, the bottle to be refilled 14 is unique but, in other embodiments not shown, the system can include several bottles to be refilled which can be refilled simultaneously in parallel or sequentially from a single refill. Hereafter in the description the liquid L to be transferred which is contained in the refill 12 (FIG. 1) is a liquid that is generally more viscous than perfume, such as for example dishwashing liquid, shower gel or oil. Generally, when a liquid of this type is transferred by means of a transfer device with liquid and air ducts like that described in patent brevet EP 2 500 277, the viscosity of the liquid considerably increases the time that this liquid takes to flow by gravity from the refill placed in the high position to the bottle to be refilled placed in the low position. Depending on the viscosity of the liquid, the ducts of this transfer device can moreover even become blocked, thus preventing any liquid transfer. On the other hand, the system 10 shown in FIG. 2 allows transferring this type of liquid more rapidly than with the transfer device described in patent EP 2 500 277, while avoiding the blockage problems mentioned above.

The system 10 comprises a liquid transfer device or interface 16 which is able to be attached, particularly by screwing, to the refill 12, and also to be attached to the bottle to be refilled 14, for example by screwing (in other embodiments the liquid transfer device may not be attached to the bottle to be refilled but simply functionally associated with the latter, for example by being partially engaged in an upper opening of the bottle to be refilled or even arranged just at this opening). In use, the system of FIG. 1 is arranged so that the refill 12 is positioned in the upper portion, the liquid transfer device 16 placed below the refill 12 and the bottle to be refilled 14 placed below the liquid transfer device 16. When the system is not in use and the liquid transfer device 16 is attached to the refill, the assembly formed from the liquid transfer device 16 and from the refill 12 can be inverted relative to the arrangement of FIG. 1 and the transfer device is then arranged above the refill which can be placed on a support (a table for example . . . ).

The refill 12 can commonly be a bottle or a cylindrical tube filled with liquid, perhaps a container with another shape. In the present embodiment, the refill is a manually deformable container with shape memory. That means that a user can deform it using a hand, for example by pressing on the outer envelope of the container with the fingers of the same hand (in a fist-tightening gesture) so as to compress this envelope and thus reduce its internal volume (FIG. 1). When the pressure exerted by the hand ceases, the outer envelope of the container is no longer subjected to any external compression stress and resumes its initial, non-deformed shape. The outer envelope of the container is thus elastically deformable, this in a manner repeated over time, without the container being damaged by the repeated deformation (by compression) operations and returning to the initial shape after release of the pressure. The term “manually deformable” signifies that the container can be deformed by only the force exerted by one person, but that does not exclude that the container can be deformed by means of a machine or of a mechanism which would exert this force directly on the container.

Here the refill 12 has a threaded neck 12a on its outer surface for cooperating with a first complementary threaded portion of the liquid transfer device 16. The refill 12 also generally has a relatively high volume capacity to be able to fill several empty containers or bottles.

It will be noted that the containers or bottles to be refilled/filled may not be totally empty before being refilled, for example to introduce into it another liquid than that already present for the purpose of mixture. The bottle to be refilled 14 can be a rigid container or a manually deformable container with shape memory or not (for example a pouch made of flexible plastic material). The bottle to be refilled 14 can also have a threaded neck 14a on its outer surface for cooperating with a second complementary threaded portion of the liquid transfer device 16.

The liquid transfer device 16 illustrated in more detail in FIGS. 2 to 4 mainly comprises two parts 18 and 20 which are bonded to one another in translation and which are mounted in rotation relative to one another around an axis Z corresponding to the longitudinal axis along which are positioned the refill 12, the transfer device 16 and the bottle to be refilled 14 (vertical axis Z in FIGS. 1 and 2).

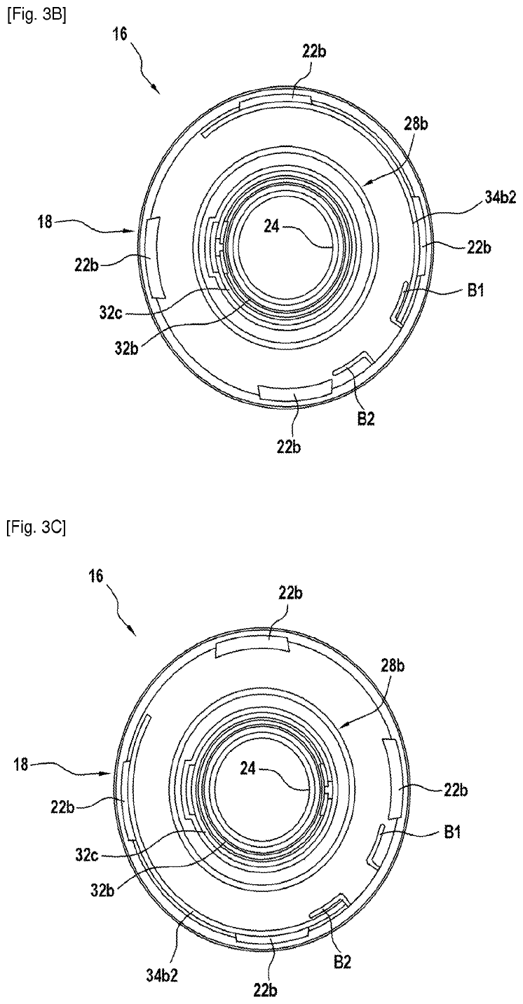

The two parts 18 and 20 both have a central portion with a substantially cylindrical shape which cooperates coaxially with one another and these two central portions are able to rotate relative to one another around the axis Z to pass from a first relative rotation position allowing the transfer of liquid (FIGS. 2 and 3B) to a second relative rotation position preventing the transfer of liquid (FIGS. 3C and 5).

The first part 18 includes, from outside to inside (taken in a radial direction relative to the axis Z), seen in transverse section in FIG. 2 and in perspective in FIG. 3A:
a first outer portion with a generally cylindrical shape which constitutes the outer envelope of the part, forming an outer skirt 22, which the user can handle to rotate the first part 18 relative to the second part 20;
a second central portion 24 already mentioned above and which has the general shape of a cylinder or of a cylindrical well open at its upper end 24a to be in fluid communication with the interior of the refill 12 and partially closed at its lower end 24b so as to provide an opening or port 24c, shaped for example like a half-moon (FIG. 3A), for the passage of the liquid to the bottle to be refilled; this central portion 24 extends axially to a station located below that of the lower end 22a of the outer skirt;
a third portion 26, shaped for example like an annular ring which includes on its inner surface a thread 26a complementary to the outer thread 12a of the neck of the refill 12 in order to attach the first part 18 to the refill by screwing, thus allowing the device 16 to be interfaced mechanically with the refill 12 (alternatively, other means of attachment of the first part 18 to the refill 12 can be contemplated);
a fourth intermediate portion 28 which connects the third threaded portion 26 to the second central portion 24 with a shape which, in transverse section (FIG. 2), comprises a first horizontal rim 28a (annular) followed by an axial drop 28b forming a slot (annular trench) which rises axially to a station higher than that of the first rim 28a to form a second horizontal rim 28c which joins the upper end 24a of the second central portion 24; the lower zone of the slot 28b being provided with an axial extension 28b1 (annular) which forms an internal shoulder with the slot.

The first part 18 shown in perspective bottom view in FIG. 3A and showing the partially open cylindrical central portion 24 which protrudes axially relative to the outer skirt 22. The first part 18 also includes (FIGS. 3A-C), provided on the inner surface of the skirt 22, two angular stop elements B1 and B2 forming protrusions, in proximity to one another and each of which is intended to cooperate with one of the two opposite ends of a wall of the second part 20 (cylindrical wall portion 34b2 which will be described below in relation to the second part 20). Each of the angular stop elements B1 and B2 comprises a cylindrical wall portion (short) radially separated from the inner surface of the skirt 22 and a radial bottom end which radially connects the cylindrical wall portion with the inner surface while forming a corner, so as to define an inner space between the cylindrical wall portion and the inner surface of the skirt 22. This inner space is closed at one end by the radial bottom and is open at the opposite end to receive one of the two opposite ends of the wall of the part 20. Other forms of angular stop elements can alternatively be contemplated.

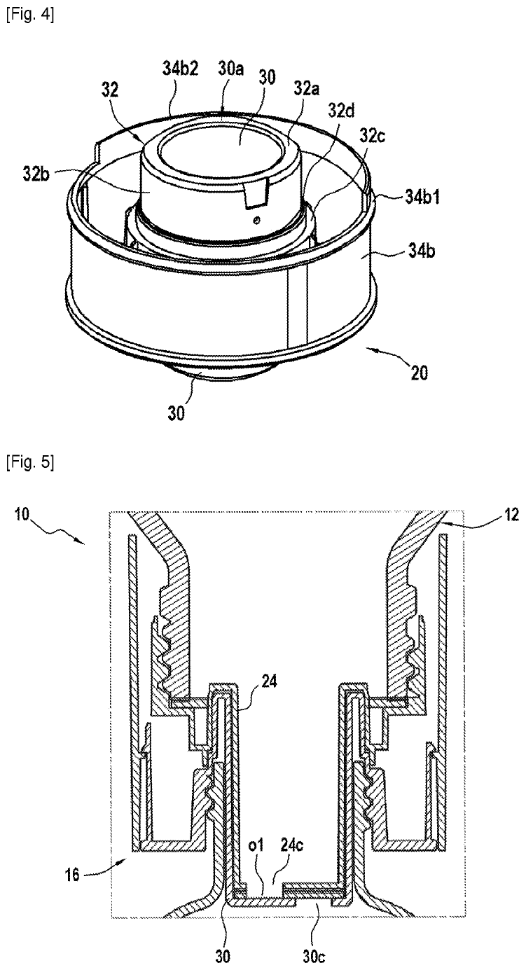

The second part 20, for its part, includes (FIGS. 2 and 4):
a first central portion 30 already mentioned above which has the general shape of a cylinder or a cylindrical well open at its upper end 30a and partially closed at its lower end 30b so as to provide an opening or port 30c, for example shaped like a half-moon, for the passage of the liquid to the bottle to be refilled when this opening 30c is aligned or in geometric correspondence with the corresponding shaped opening 24c of the central portion of the first part 18;
a second portion 32 which first extends radially outward (moving away from the axis Z) from the upper end 30a of the first portion in the form of a first horizontal rim 32a (annular), then axially downward in the form of a first cylindrical portion or skirt 32b followed by a second cylindrical portion or skirt 32c offset radially outward relative to the first portion 32b, after having formed an outer shoulder 32d, and which for example takes the shape of an annular ring including, on its inner surface, a thread 32c1 complementary to the outer thread 14a of the neck of the bottle to be refilled 14 in order to attach the second part 20 by screwing to the bottle to be refilled, thus allowing the device 16 to be interfaced mechanically with the bottle to be refilled (alternatively, other means of attaching the second part 18 to the refill can be contemplated; the annular ring 32c extends axially to the station corresponding with that of the lower end 22a of the outer skirt 22;
a third portion 34 which first extends radially outward (moving away from the axis Z), starting from the lower end 32c2 of the annular ring 32c, in the form of a second horizontal rim 34a (annular), then axially upward in the form of a substantially cylindrical wall 34b which includes on its outer surface an external shoulder (annular) 34b1 forming a protrusion which cooperates mechanically with one of the inner protruding elements 22b provided on the inner surface of the outer skirt 22 (FIG. 2), thus allowing blocking the second part 20 in downward axial translation relative to the first part 18 (to prevent axial withdrawal of one part relative to the other); the substantially cylindrical wall 34b of the second part 20 is extended upward by a cylindrical wall portion 34b2 over an angular sector of the part, for example less than 180° (for example: 160°), as illustrated in the perspective of FIG. 4. This wall or angular segment portion 34b2 is able to be inserted through one of these two opposite ends into the space internal to the angular stop element B1, in the open position of the liquid transfer device (FIG. 3B) and be inserted by its opposite end into the space internal to the angular stop element B2 in the closed position of the liquid transfer device (FIG. 3C).

As shown in FIG. 2, the two parts 18 and 20 which here are respectively attached to the refill and to the bottle to be refilled are axially interlocked one in the other, due to the elasticity of the thinned cylindrical wall 34b of the second part 20 relative to the second rim 34a of the same part, so as to adopt the position of FIG. 2, in which the two parts are held bonded in axial translation by means of the mechanical arrangement described above. In this interlocked configuration the second central portion 24 and the third portion 28 of the first part 18 cap the second part 20 and, more particularly its first 30 and second 32 portions, by wedging itself axially on the outer shoulder 32a of the second portion with the inner shoulder located below the slot 28c of the third portion of the first part. This wedging or axial support allows completing the axial blockage of the two parts in order to axially limit the internal engagement of the two parts relative to one another (the second part 20 is thus blocked in upward translation). Just as for the blockage in downward translation of this part, other means with different structures can of course be contemplated.

Thus interlocked with one another, the second central portion 24 of the first part 18 is housed inside the first central portion 30 of the second part. A gasket J1 is positioned horizontally between the two respective partially open bottoms of the second central portion 24 and of the first central portion 30. This gasket is also perforated in its thickness by an opening o1 with a shape identical to that of the openings 24c and 30c.

Another gasket J2 is positioned horizontally between the free edge 12b of the refill 1 and the annular rim 28a of the first part 18 in order to achieve liquid- and airtightness between this part and the refill 12. This gasket J2 also extends radially until coming into contact with the axial extension of the slot 28b. The gasket can for example take the form of an annular collar or washer.

In the position illustrated in FIG. 2 (first relative rotation position of the transfer device 16), the two respective openings 24c and 30c and the opening o1 (shaped like a half-moon for example) of the gasket J1 coincide geometrically with one another (axial alignment) to allow the liquid present in the refill and in the internal volume of the second central portion 24 to flow through these openings right into the bottle to be refilled 14. In this position the two parts 18 and 20 are configured jointly, in particular here by means of their axially pierced central portions and interlocked with one another, so as to define an internal (axial) passage for the liquid from the refill 12 to the bottle to be refilled 14. In the present embodiment, the internal passage is formed by the assembly of the successive openings 24c and 30c aligned axially with one another and each of which constitutes a passage portion in fluid communication with the other passage portion (which must be added the opening o1 of the gasket in this embodiment, but this opening o1 may not be present in another embodiment not shown here).

Generally, this passage for the liquid has a passage cross section offered to the liquid which is comprised between 5 mm² and 100 mm², preferably between 50 and 100 mm². In the present embodiment, this passage has for example a passage cross section equal to 67 mm². Generally, the passage cross section takes into account the flow speed of the liquid and/or its viscosity. In the case where the system has a slight recovery of outside air, the passage cross section of this outside air recovery does not exceed 5 mm² when the passage cross section offered to the liquid is comprised between 50 and 100 mm². Generally, the air entering into the refill so that the liquid transfer can be carried out originates mainly, perhaps essentially, from the bottle to be refilled through the liquid passage between the two bottles.

In the position illustrated in FIG. 5 (second relative rotation position of the transfer device 16), the second part 20 has rotated around the axis Z relative to the first part 18 by a predetermined angle, 180° for example, and the opening 30c is no longer in geometric correspondence with the openings 24c and o1, thus preventing the transfer of liquid from the refill to the bottle to be refilled. In this position, the liquid passage is obstructed. The two passage portions for the liquid formed by the respective openings 24c and 30c of the two parts are no longer aligned with one another and therefore no longer provide fluid communication between the passage portions.

It will be noted moreover that in this configuration the radial dimensions (taken perpendicular to the longitudinal axis Z) of the space defined between the first central portion 30 and the two axial extension portions 32b, 32c are adjusted so that the space defined between the inner surface of the neck of the bottle to be refilled 14 and the outer surface of the first central portion 30 is as small as possible in order to form a liquid-tight zone between the liquid transfer device 16 and the bottle to be refilled 14.

Moreover, the liquid transfer device 16 does not include an air passage distinct from the liquid passage, unlike the transfer device of patent EP 2 500 277. As will be understood hereafter during the description of the operation of the system, in the present embodiment, the air rises from the bottle to be refilled 14 into the refill 12 though the liquid passage defined above to compensate the volume of liquid transferred, through the same passage, from the refill 12 to the bottle to be refilled 14. However, the liquid transfer is not accomplished at the same time as the passage of air bubbles, but rather alternately.

The shapes of the parts 18 and 20 of the liquid transfer device described above are likely to vary depending on the embodiments of the invention. However, regardless of their shapes, these parts are interlocked with one another, mounted in rotation relative to one another along a predefined angular sector (the angular stop means or members of the two parts can take varied shapes) and axially bonded to one another. These parts can be attached or not to the refill and to the bottle to be refilled and, if attached, the attachment means can vary from one embodiment to the other. In particular, the central portions 24 and 30 of the two parts can be shortened to stop at the free edge 14b of the neck of the bottle to be refilled 14 or in proximity to it (at a station lower than that of the free edge). The other portions of the two parts can also take on other shapes.

The operation of the system according to the present embodiment is explained hereafter.

In the first place, the first part 18 of the liquid transfer device 16 is attached by a user to the refill 12, for example by screwing as already described above. This step is accomplished on the refill 12 of which the open neck is oriented upward. For this operation, the transfer device 16 is in the closed position of FIG. 5 (second relative rotation position) where the respective openings of the two parts 18, 20 are radially offset relative to one another in order to obstruct the passage for the liquid.

The liquid transfer device 16, still in the closed position, is then attached to the bottle to be refilled 14 by the user (in the present embodiment), by screwing for example as already described above. This step can occur while the transfer device 16 attached to the refill 12 is arranged above it (in this case the bottle to be refilled must be empty to be able to be turned over) or by turning over the assembly formed by the transfer device and the refill attached to the latter as in the position of FIG. 1.

The user seizes the device 16 by the outer skirt 22 and screws the device 16 (the refill 12 that is attached to it follows the screwing movement) by means of the second part 20 to the neck of the bottle to be refilled 14 (the two parts 18 and 20 do not rotate relative to one another because friction forces are generated between the two parts in contact with the first gasket J1 and thus impose a torque resisting the clamping force) until the end of the screwing movement is reached (arrival at the end of the thread).

When the liquid transfer device 16 is attached to the bottle to be refilled 14 and thus forms a fluid interface between these two containers, the system 10 thus formed is in the position of FIG. 1, but with the liquid transfer device 16 in the closed position of FIG. 5. The two parts 18 and 20 are in the relative rotation position of FIG. 3C.

The user can continue the screwing movement of the device 16 on the bottle to be refilled by continuing to rotate the device 16 (with the associated refill) relative to the bottle to be refilled 14, and then begin to rotate one of the two parts relative to the other part. In particular, the user who directly seizes the outer skirt 22 of the first part 18 with the fingers of one hand rotates the first part 18 with the associated refill 12 relative to the second part 20 and to the associated bottle 14 that the user can held fixed with the other hand. Alternatively, the user can, by rotating the bottle 14 and the second associated part 20 with the fingers of one hand, rotate this part relative to the first part 18 with the associated refill that the user can hold fixed with the other hand applied to the outer skirt 22. This rotation movement which follows the screwing operation has as its purpose to cause the liquid transfer device 16 to pass from the closed position of FIG. 5 (second relative rotation position) to the open position of FIG. 2 (first relative rotation position). The rotation movement of one of the two parts relative to the other (a half-turn for example) continues until one of the parts encounters one of the angular rotation stops which is provided on the other part, thus ending the rotation. In the present case, the angular segment 34b2 engages into the semi-open space forming the angular stop B1 as illustrated in 3B (it is the second part 20 which rotates relative to the first part 18 in this example). The liquid transfer device 16 is then fully open as in FIGS. 1 and 2 (it will be noted that this gesture is particularly simple for the user because in continuing the operation consisting of rotating the device relative to the bottle to be refilled the user brings the liquid transfer device into a position ready for the transfer (device open). In this position, the two parts 18, 20 jointly define the passage defined above (via their aligned openings) for the transfer of liquid from the refill 12 to the bottle to be refilled 14. It will be noted however that, with no additional action by the user, in this example where the container of the refill has shape memory, the liquid remains in the refill due to its viscosity.

During the following step, the user exerts external pressure on the outer envelope of the refill 12 with the fingers of one hand as illustrated in FIG. 1, which deforms the envelope, increases the internal pressure in the refill and thus exerts a descending vertical thrust on the liquid, the flow of which through the liquid passage of the transfer device 16 is thus forced. A transfer of liquid L (forced flow) thus occurs from the refill 12 to the bottle to be refilled 14 through the aligned openings 24c, o1 and 30c in the form of drops G of liquid or a liquid stream depending on the viscosity of the liquid, the passage cross-section of the openings and the external pressure applied. The quantity of liquid transferred depends in particular on these parameters.

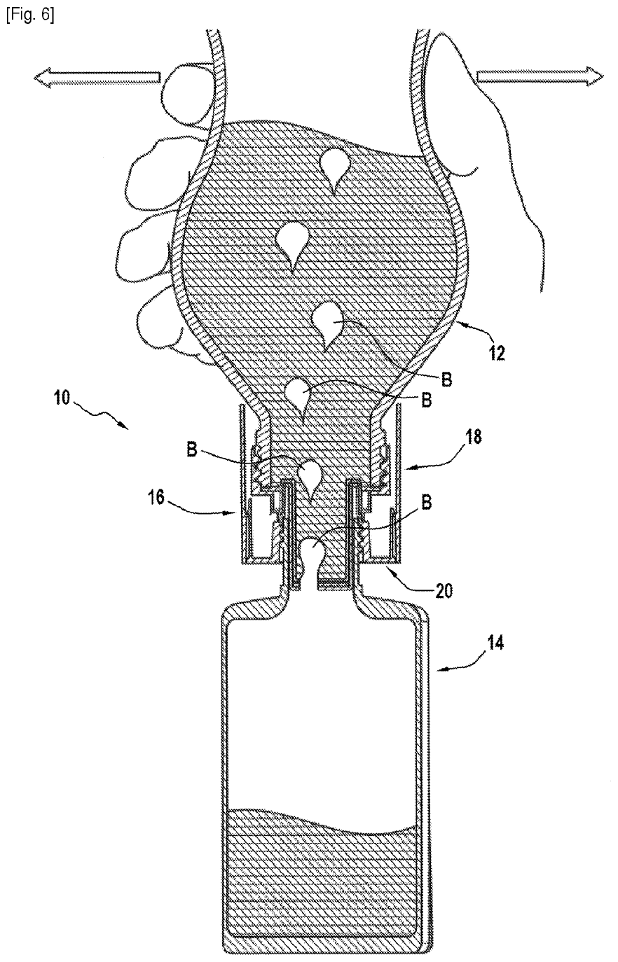

After having pressed the refill 12 to transfer a quantity of liquid into the bottle 14, the user releases the pressure on the refill as illustrated in FIG. 6, which causes a reduced pressure in the refill and the rise of air bubbles B by aspiration, from the bottle 14 into the refill 12, thus balancing the pressures inside the system between the refill and the bottle. By releasing the pressure on the refill, the outer envelope of the latter resumes its initial non-deformed shape.

The user can repeat the operations described above one or more times (application of pressure/pressing and releasing of pressure) in order to fill/refill more or less the bottle 14. If the bottle has a relatively small volume, it can be filled in a single phase (application of pressure and release of pressure).

After having filled the bottle 14, the user closes the liquid transfer device 16 by bringing it into the position of FIG. 5 by rotation in the opposite direction: the user rotates the second part 20 relative to the first part 18 (held immovable on the outside, for example, by its outer skirt 22) in the opposite direction from the direction of rotation used for opening and filling (here over 180°), until it attains the second angular rotation stop of the two of FIG. 3C. At the end of the rotation movement identified by the angular abutment of the two parts with respect to one another, the liquid transfer device 16 is in the closed position of FIG. 5 (passage of liquid obstructed in the second relative rotation position).

By continuing the rotation movement of the second part 20 (the first part 18 is also driven in rotation), the user thus proceeds with the unscrewing of the second part 20 relative to the bottle 14, thus allowing separating the liquid transfer device 16 from the bottle 14. It will be noted that the user who rotates the second part 20 relative to the first part 18 or who rotates the first part 18 (by its external skirt or ring 22) relative to the second part 20 (according to the embodiments contemplated) does not necessarily understand the mechanism that he is activating. Thus, he may not be aware of the moment when the screwing is terminated and where the phase of opening the liquid transfer device begins. These two phases are generally transparent to the user.

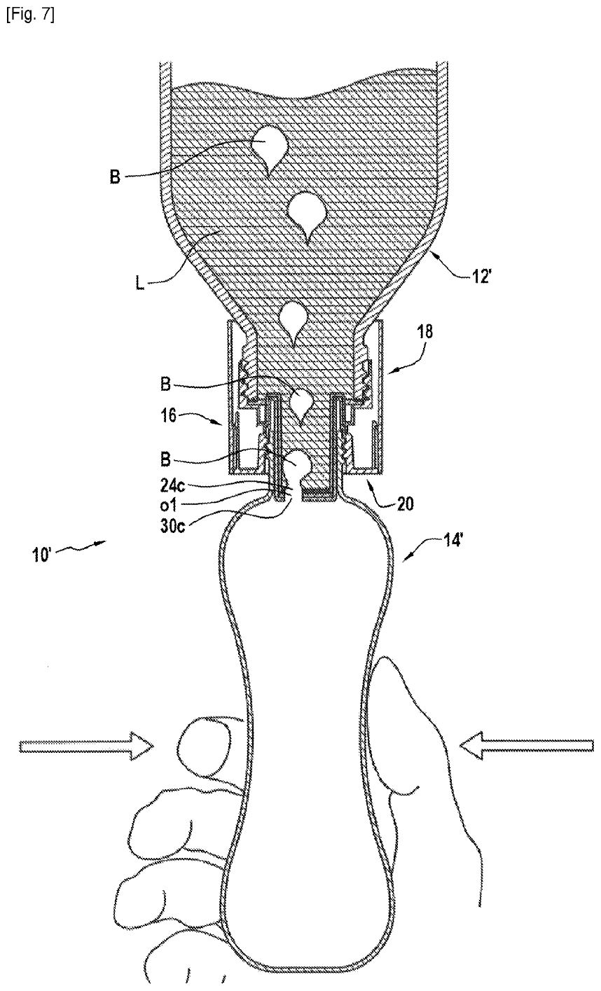

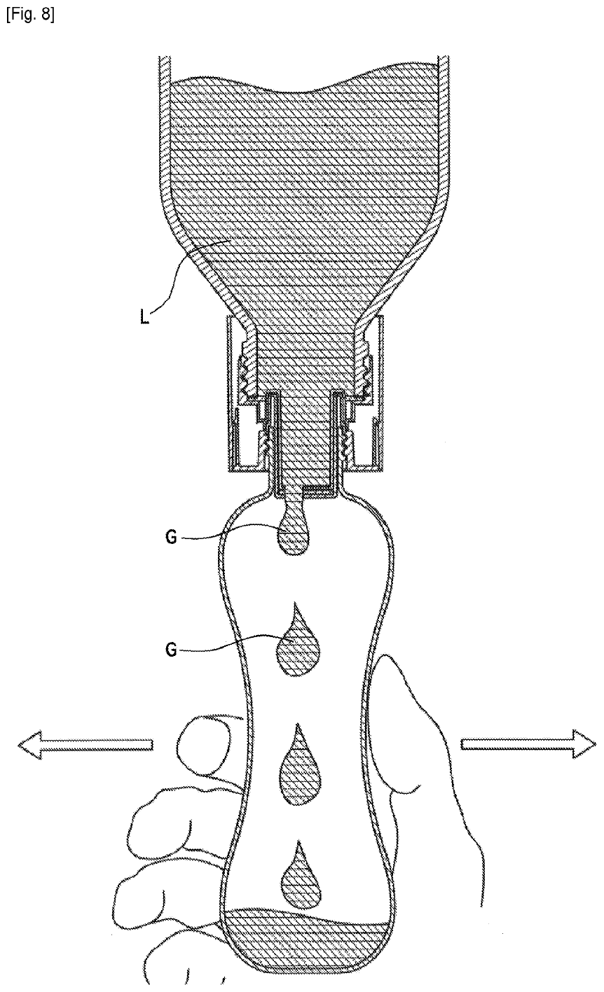

FIGS. 7 and 8 illustrate a liquid transfer system 10′ according to another embodiment of the invention, in which the bottle to be refilled 14′ is a manually deformable container with shape memory, like the container constituting the refill 12 in FIG. 1, and the refill 12′ can be of the same type, or a rigid or flexible (plastic pouch type) container without shape memory.

In this embodiment, the liquid transfer device 16 is the same as that of FIG. 1, and all that has been described above in relation to FIGS. 1 to 6 applies, with the exception however of the refilling method or the system implementation which is different. The operations of attaching the transfer device 16 to the refill and to the bottle to be refilled are the same as before. However, to transfer liquid from the refill 12′ to the bottle to be refilled 14′ when the transfer device 16 is in the open position of FIG. 2, the user exerts external pressure on the outer envelope of the bottle to be refilled 14′ with the fingers of one hand as illustrated in FIG. 7, which deforms the envelope, increases the internal pressure of the bottle 14′ and thus exerts a rising vertical thrust on the air contained in the bottle, which is driven out in the form of air bubbles B to the refill 12′ through the aligned openings 24c, o1 and 30c of the transfer device 16.

After having pressed the bottle to be refilled 14′, the user releases the pressure on the latter as illustrated in FIG. 8, and the outer envelope of the bottle to be refilled tends to resume its initial non-deformed shape. An aspiration of liquid is thus created in the bottle to be refilled 14′, together with a descending vertical thrust effect exerted on the liquid of the refill 12′ by the air introduced into this refill, in order to balance the pressure inside the system between the refill and the bottle. The flow of liquid (transfer) through the aligned openings 24c, o1 and 30c of the transfer device 16 is thus forced in the form of drops G of liquid or of a stream of liquid passing through the open passage, depending on the viscosity of the liquid, the passage cross section of the openings and the external pressure applied. The quantity of liquid transferred depends in particular on these parameters.

Just as for the embodiment of FIGS. 1 to 6, these operations (pressure/pressing and releasing) can be repeated to completely refill/fill the bottle to be refilled 14′.

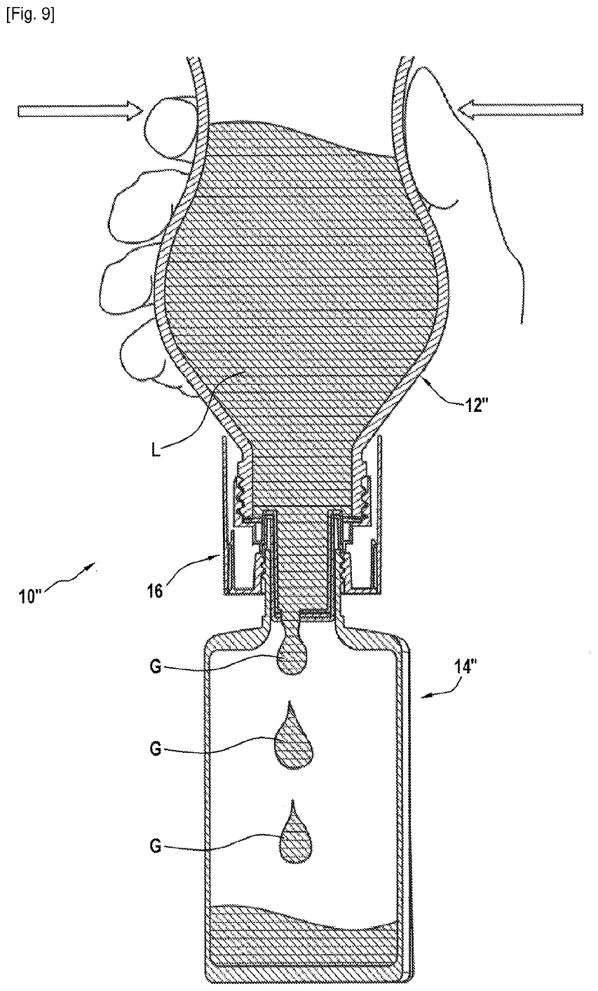

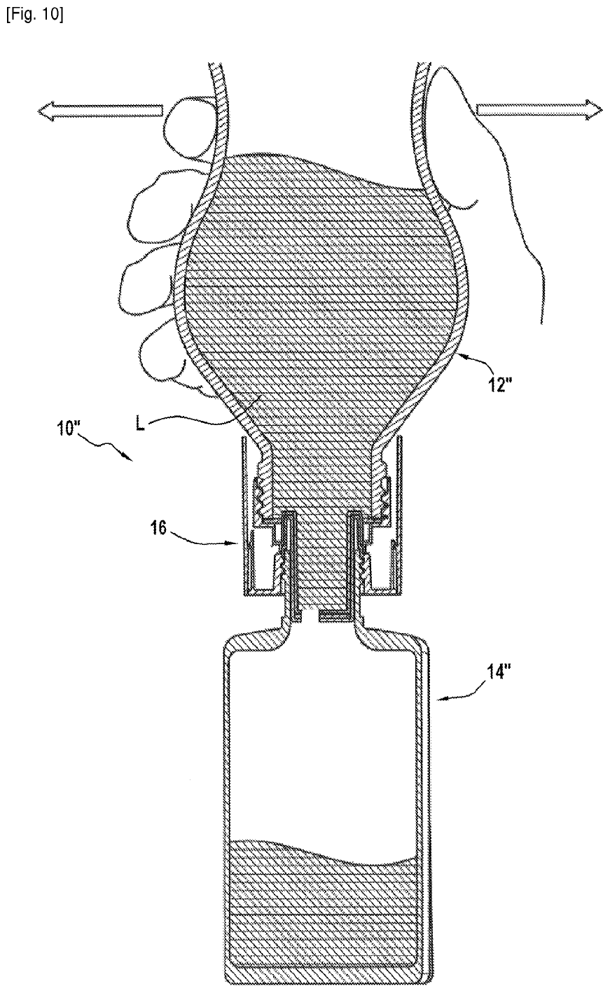

FIGS. 9 and 10 illustrate a liquid transfer system 10″ according to still another embodiment of the invention, in which the bottle to be refilled 14″ is a container like the container constituting the bottle to be refilled 14 in FIG. 1, i.e. rigid or manually deformable with shape memory, and the refill 12″ is a manually deformable container but without shape memory (for example of the plastic pouch type).

In this embodiment, the liquid transfer device 16 is the same as that of FIG. 1 and all that has been described above in relation with FIGS. 1 to 6 applies, with the exception however of the refilling method or the implementation of the system, which is different: in fact, here the user presses on the outer envelope of the refill 12″ to deform it manually and cause the transfer of liquid G as described above. However, this operation need not be followed by a release of the pressure exerted to balance the pressures between the two containers, inasmuch as the container 12″ is not of the type having shape memory. Thus, even by releasing the pressure, as illustrated in FIG. 10, the container 12″ does 5 not resume its initial shape. After having carried out a transfer of a certain quantity of liquid to the bottle to be refilled 14″, the user can continue to press the refill 12″ to transfer more liquid to the bottle to be refilled to fill it, or stop and close the liquid transfer device 16, then separate the latter from the bottle to be refilled 14″ as described above.

1. A method for refilling at least one bottle with liquid in a system (10) comprising, with the system arranged vertically along an axis (Z):
a refill (12) containing liquid,
at least one bottle to be refilled (14) arranged below the refill, said at least one bottle to be refilled and/or the refill being produced in the form of a manually deformable container,
a device for transferring liquid (16) arranged between the refill (12) and said at least one bottle to be refilled (14), the liquid transfer device comprising at least two parts (18, 20) which are, on the one hand, mounted in rotation relative to one another around the axis (Z) and, on the other hand, bonded in axial translation along the axis (Z), a first (18) of the two parts being attached to the refill (12),
the method comprising the following steps:
rotating one of the two parts (18, 20) relative to the other part in order to bring the two parts into a first relative rotation position wherein the two parts jointly define at least one passage for the liquid from the refill to said at least one bottle to be refilled, namely a single liquid passage per bottle to be refilled,
exerting external pressure on the manually deformable container or on one of the two manually deformable containers for the purpose, on the one hand, of causing a transfer of liquid from the refill (12) to said at least one bottle to be refilled (14) through said at least one liquid passage of the transfer device (16) and, on the other hand, causing the air contained in said at least one bottle to be refilled to rise into the refill through said at least one liquid passage.

2. The method according to claim 1, characterized in that the method also comprises the following step:
rotating one of the two parts (18, 20) relative to the other part, in the direction opposite to that of the preceding relative rotation movement between the two parts, in order to bring the two parts into a second relative rotation position wherein said at least one liquid passage is obstructed.

3. The method according to claim 1 or 2, characterized in that, after having exerted external pressure on the manually deformable container or on one of the two manually deformable containers, the method comprises the following step of releasing the exerted external pressure.

4. The method according to claim 3, characterized in that it comprise the following step or repeating the actions of exerting external pressure on the manually deformable container having shape memory or on one of the two manually deformable containers having shape memory and releasing the external pressure to refill said at least one bottle to be refilled.

5. The method according to one of claims 1 to 4, characterized in that, the refill being produced in the form of a manually deformable container having shape memory, the method comprises the steps of:
exerting external pressure on the manually deformable container of the refill in order to transfer liquid from the refill to said at least one bottle to be refilled,
and releasing the external pressure on the manually deformable container of the refill in order to cause the air from said at least one bottle to be refilled to rise into the refill.

6. The method according to one of claims 1 to 4, characterized in that said at least one bottle to be refilled being produced in the form of a manually deformable container with shape memory, the method comprises the steps of:
exerting external pressure on the manually deformable container of said at least one bottle to be refilled in order to cause the air from said at least one bottle to be refilled to rise into the refill,
and releasing the external pressure on the manually deformable container of said at least one bottle to be refilled in order to cause the transfer of liquid from the refill to said at least one bottle to be refilled by aspiration of the liquid contained in the refill.

7. The method according to one of claims 1 to 6, characterized in that the method comprises a step during which the liquid transfer device is rotated relative to said at least one bottle to be refilled, first, to screw the liquid transfer device to said at least one bottle to be refilled and, then, to rotate one of the two parts (18, 20) relative to the other part in order to bring the two parts into the first relative rotation position wherein the two parts jointly define said at least one passage for the liquid from the refill to the at least one bottle to be refilled.

8. A system (10; 10′; 10″) for refilling at least one bottle with liquid, comprising, with the system arranged vertically along an axis (Z):
a refill (12; 12′; 12″) containing liquid,
at least one bottle to be refilled (14; 14′; 14″) arranged below the refill,
a liquid transfer device (16) arranged between the refill and said at least one bottle to be refilled, the liquid transfer device comprising at least two parts (18, 20) which are, on the one hand, mounted in rotation relative to one another around the axis Z between a first relative rotation position and a second relative rotation position and, on the other hand, bonded in axial translation along the axis Z, a first (18) of the two parts being attached to the refill, the two parts (18, 20) being jointly configured so as to define at least one passage for the transfer of the liquid from the refill to said at least one bottle to be refilled and the transfer, to the refill, of the air contained in said at least one bottle to be refilled, in the first relative rotation position, and to obstruct said at least one liquid passage, in the second relative rotation position,
said at least one bottle to be refilled (14; 14′; 14″) and/or the refill (12; 12′; 12″) being produced in the form of a manually deformable container and able to be deformed manually under the influence of external pressure to cause a variation of internal pressure in the container thus deformed.

9. The system for refilling at least one bottle with liquid according to claim 8, characterized in that said at least one passage for the liquid defined in the transfer device (16) when the latter is in the first relative rotation position has a passage cross section comprised between 5 mm² and 100 mm², preferably between 50 and 100 mm².

10. The system for refilling at least one bottle with liquid according to claim 8 or 9, characterized in that the liquid transfer device (16) comprises, in each of the two parts (18, 20), at least one passage portion configured so that, when the two parts are in the first relative rotation position, the passage portions of the two parts are in fluid communication with one another in order to define said at least one passage for the liquid and, when the two parts are in the second relative rotation position, the passage portions of the two parts are not in fluid communication with one another.

11. The system for refilling a least one bottle with liquid according to one of claims 8 to 10, characterized in that the second part (20) is attached to said at least one bottle to be refilled (14; 14′; 14″).

12. The system for refilling at least one bottle with liquid according to claim 11, characterized in that the second part (20) is attached to said at least one bottle to be refilled (14; 14′; 14″) by screwing.

13. The system for refilling at least one bottle with liquid according to one of claims 8 to 12, characterized in that the refill (12; 12′; 12″) is selected among a manually deformable container with shape memory or a manually deformable container without shape memory.

14. The system for refilling at least one bottle with liquid according to one of claims 8 to 13, characterized in that the system includes a liquid-tight zone between the liquid transfer device (16) and said at least one bottle to be refilled (14; 14′; 14″).
